(19) United States
(12) Patent Application Publication
(10) Pub. No.: US 2025/0068968 A1
(43) Pub. Date: Feb. 27, 2025

(54) DYNAMIC EMBEDDING-BASED MACHINE LEARNING TRAINING MECHANISM FOR EFFICIENT AND AGILE INTEGRATION OF NEW INFORMATION

(71) Applicant: NEC Laboratories Europe GmbH, Heidelberg (DE)

(72) Inventors: Timo Sztyler, Heidelberg (DE); Shalini Shalini, Heidelberg (DE)

(21) Appl. No.: 18/527,441

(22) Filed: Dec. 4, 2023

Related U.S. Application Data
(60) Provisional application No. 63/534,371, filed on Aug. 24, 2023.

(51) Int. Cl. G06N 20/00

(52) U.S. Cl. CPC G06N 20/00

(57) ABSTRACT

A computer-implemented, machine learning method for a dynamic embedding-based machine learning training mechanism includes training, using an initial optimizer, an embedding-based neural network model based on a dataset to generate an initial computational graph having trainable variables. Based on receiving a new dataset: a new computational graph is generated, instantiated with new embedding dimensions migrated from the initial computational graph; a new optimizer is generated based on a weight matrix that fits to the trainable variables of the new computational graph; and weights of the trainable variables from the initial optimizer are migrated to the new optimizer. The embedding-based neural network model is trained with the new dataset by updating embeddings and learning new embeddings of the new dataset. The present invention can be used in a variety of applications including, but not limited to, several anticipated use cases in drug development, public safety, and medical/healthcare.

### CROSS-REFERENCE TO PRIOR APPLICATION

Priority is claimed to U.S. Provisional Application Ser. No. 63/534,371 filed on Aug. 24, 2023, the entire contents of which is hereby incorporated by reference herein.

### FIELD

The present invention relates to Artificial Intelligence (AI) and machine learning (ML), and in particular to a method, system, data structure, computer program product and computer-readable medium for a dynamic embedding-based machine learning training mechanism, a model so trained, and application of such a trained model to an AI system or ML task.

### SUMMARY

In an embodiment, the present invention provides a computer-implemented, machine learning method for a dynamic embedding-based machine learning training mechanism. a) An embedding-based neural network model is trained, using an initial optimizer on a processor, to generate an initial computational graph having trainable variables. b) Based on receiving a new data set that extends the data set: the processor generates a new computational graph of the embedding-based neural network model instantiated with new embedding dimensions migrated from the initial computational graph, the new computation graph having the trainable variables: a new optimizer is generated on the processor based on a weight matrix that fits to the trainable variables of the new computational graph: and weights of the trainable variables from the initial optimizer are migrated to the new optimizer. c) The embedding-based neural network model is trained with the new data set by updating embeddings of the embedding-based neural network model and learning new embeddings of the new data set. The present invention can be used in a variety of applications including, but not limited to, several anticipated use cases in drug development, public safety, and medical/healthcare.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a DistMult deep learning process and architecture:

FIG. 2 schematically illustrates a method and system architecture of a dynamic embedding-based machine learning mechanism according to an embodiment of the present invention:

FIG. 3 schematically illustrates the migration of the embedding weights across computational graphs while training according to an embodiment of the present invention:

FIG. 4 schematically illustrates a training procedure according to an embodiment of the present invention:

FIG. 5 schematically illustrates a method for adapting dimensions from step 1 to step 2 of FIG. 1 according to an embodiment of the present invention; and

FIG. 6 is a block diagram of an exemplary processing system, which can be configured to perform any and all operations disclosed herein.

### DETAILED DESCRIPTION

Embodiments of the present invention provide a mechanism to continuously train an embedding-based machine learning model that is able to dynamically adapt the feature or embedding dimensions during the training process. Improvements to computer functionality and advantages provided by embodiments of the present invention include enhancing the computational performance of the AI system, improving computational speed and power, and/or saving computational resources because training data does not need to be permanently stored, the AI model does not need to be re-trained, and new information can be integrated faster and more effectively, thereby also improving accuracy of the AI system and providing flexibility to applications in which new information becomes available over time. In addition to these general improvements to computer functionality of the AI system, Embodiments of the present invention can also be practically applied to effect further improvements in a number of technical fields through the ability to more effectively integrate new information. For example, embodiments of the present invention can be advantageously applied to various use cases to enhance the AI systems in domains such as public safety (e.g., in smartcity applications or in forensic tools), healthcare (e.g., for digital medicine, AI-assisted drug (or vaccine) development, personalized medicine and other AI-based medical applications), and product development (e.g., material informatics, design or smart manufacturing).

Embodiments of the present invention provide solutions to the technical problem of introduction of new nodes or relations in a knowledge graph which were not present at training time. This technical problem is a result of trained machine learning models relying on the data on which they were trained to make predictions. According to existing technology, new nodes or relations either cannot be handled at all or are not appropriately handled and cause interferences. In the end, this technical limitation of existing technology can significantly hinder the model's ability to perform reliably and accurately. This technical problem also significantly limits the applications of existing AI systems since in many existing and potential applications new information arrives over time. To account for the new information, existing technology would require to re-train the models from scratch. Re-training entire machine learning models from scratch, however, is time and computational resource intensive, and requires to permanently store all training data.

In contrast to existing technology, embodiments of the present invention provide a mechanism to successively train an AI model to incorporate new information. As mentioned above, this improves computer functionality of the AI system enhancing the computational performance of the AI system, improving computational speed and power, and/or saving computational resources because training data does not need to be permanently stored, the AI model does not need to be re-trained, and new information can be integrated faster and more effectively, thereby also improving accuracy of the AI system and providing flexibility to applications in which new information becomes available over time. Further, embodiments of the present invention provide different mechanisms to ensure that the training procedure does not overfit over longer training time.

An exemplary embodiment discussed herein is focused on the technical problems of generic (i.e., they generalize) inductive link prediction methods as those always have limiting requirements such as a fixed set of relation types. Further, those methods are trained once and cannot adapt to new or unseen patterns or behavior. Embodiments of the present invention provide solutions to overcome these technical problems.

Existing AI frameworks such as PyTorch and Tensorflow support different executions modes such as those referred to as “Eager Mode” and “Graph Mode”. An exemplary embodiment of the present invention discussed herein focuses on the Graph Mode, as it is faster (but less dynamic) than the Eager Mode. Since it is faster, the Graph Mode can be more advantageously applied in practice where industrial application speed and performance are of higher priority, while the Eager Mode might be more used for debugging. experiments, and prototyping. A technical challenge when dealing with the execution modes is to adapt and modify different shapes and states of the computation graph and the respective optimizer. Embodiments of the present invention provide for improved dynamics of a Graph Mode.

Advantageously, embodiments of the present invention are not restricted to a specific deep learning architecture, but rather provide the flexibility to be applied to any embedding-based approach. In the following, exemplary embodiments are described for the link prediction algorithm DistMult (see Kadlec, Rudolf, Ondrej Bajgar, and Jan Kleindienst, “Knowledge base completion: Baselines strike back,” arXiv preprint arXiv: 1705.10744 (2017), which is hereby incorporated by reference herein) and also for the relational tool KBlmn (see García-Durán, Alberto, and Mathias Niepert, “KBlrn: End-to-end learning of knowledge base representations with latent, relational, and numerical features,” arXiv preprint arXiv: 1709.04676 (2017), which is hereby incorporated by reference herein).

In a first aspect, the present invention provides a computer-implemented, machine learning method for a dynamic embedding-based machine learning training mechanism. a) An embedding-based neural network model is trained, using an initial optimizer on a processor, to generate an initial computational graph having trainable variables. b) Based on receiving a new data set that extends the data set: the processor generates a new computational graph of the embedding-based neural network model instantiated with new embedding dimensions migrated from the initial computational graph, the new computation graph having the trainable variables: a new optimizer is generated on the processor based on a weight matrix that fits to the trainable variables of the new computational graph: and weights of the trainable variables from the initial optimizer are migrated to the new optimizer. c) The embedding-based neural network model is trained with the new data set by updating embeddings of the embedding-based neural network model and learning new embeddings of the new data set.

In a second aspect, the present invention provides the method according to the first aspect, further comprising predicting relational links for the new embeddings such that one or more new entities are connected to each other and/or to one or more existing entities using a link prediction embedding representation function, wherein the embeddings and the new embeddings are iteratively refined based on repeating steps b) and c) for further new data sets.

In a third aspect, the present invention provides the method according to any of the first or second aspects, further comprising removing the initial computational graph and the initial optimizer from the processor.

In a fourth aspect, the present invention provides the method according to any of the first to third aspects, further comprising applying a lossless autoencoder to the weights of the trainable variables to match the new embedding dimensions, wherein the lossless autoencoder is an unsupervised autoencoder, and wherein applying the lossless autoencoder is based on an embedding dimension of the trainable variables from the initial computational graph being modified.

In a fifth aspect, the present invention provides the method according to any of the first to fourth aspects, wherein a mapping function is defined to migrate the weights of the trainable variables from the initial optimizer to the new optimizer, wherein the mapping function is obtained using a vector-to-vector machine learning model.

In a sixth aspect, the present invention provides the method according to any of the first to fifth aspects, wherein the processor is a graphics processing unit (GPU), and wherein all operations of the initial computational graph and the new computational graph are maintained on the GPU.

In a seventh aspect, the present invention provides the method according to any of the first to sixth aspects, further comprising instantiating the new embedding dimensions and/or the weights of the trainable variables with at least random values, using a pooling mechanism based on a neighborhood of the new computational graph, or with zeros.

In an eighth aspect, the present invention provides the method according to any of the first to seventh aspects, wherein the embedding-based neural network model is used on the processor to predict potential states from the data set in parallel to training, on the processor, the embedding-based neural network model.

In a ninth aspect, the present invention provides the method according to any of the first to eighth aspects, further comprising identifying a subset of molecules from the new data set using the embedding-based neural network model, the new data set including amino acid sequences, wherein the subset of molecules is distinct from an antibiotic.

In a tenth aspect, the present invention provides the method according to any of the first to ninth aspects, wherein the trainable variables for the initial computational graph include a predefined embedding dimension, relation embeddings, and node embeddings.

In an eleventh aspect, the present invention provides the method according to any of the first to tenth aspects, further comprising removing certain evidence types from the new data set using the embedding-based neural network model, the new data set including devices used to obtain evidence or information associated with the evidence, wherein the certain evidence types correspond to a particular device of the devices or a particular piece of the evidence or the information of the evidence or the information.

In a twelfth aspect, the present invention provides the method according to any of the first to eleventh aspects, wherein the new optimizer is a re-instantiated version of the initial optimizer, the re-instantiated version of the new optimizer instantiated with new and/or different parameters.

In a thirteenth aspect, the present invention provides a computer system for a dynamic embedding-based machine learning training mechanism comprising one or more processors, which, alone or in combination, are configured to perform a machine learning method for a dynamic embedding-based machine learning training mechanism according to any of the first to twelfth aspects.

In a fourteenth aspect, the present invention provides the computer system according to the thirteenth aspect, further comprising predicting relational links for the new embeddings such that one or more new entities are connected to each other and/or to one or more existing entities using a link prediction embedding representation function, wherein the embeddings and the new embeddings are iteratively refined based on repeating steps b) and c) for further new data sets.

In a fifteenth aspect, the present invention provides a tangible, non-transitory computer-readable medium for a dynamic embedding-based machine learning training mechanism which, upon being executed by one or more hardware processors, provide for execution of a machine learning method according to any of the first to twelfth aspects.

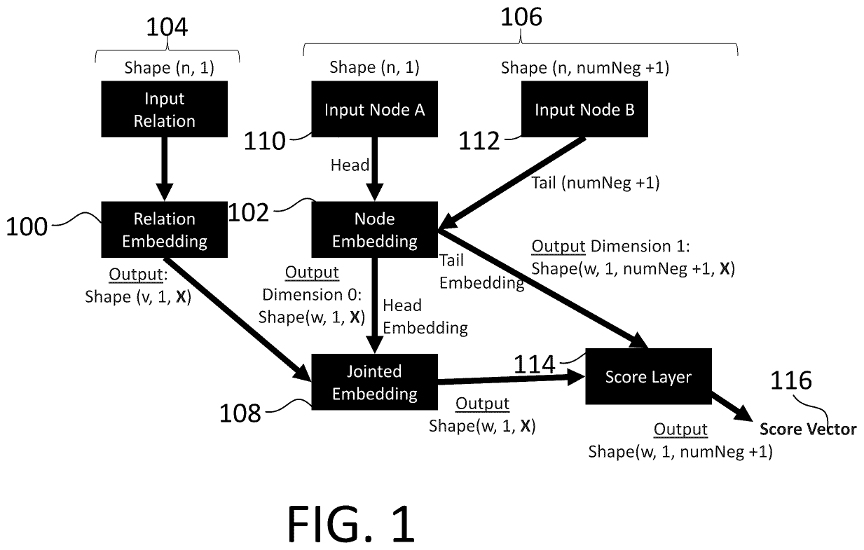

FIG. 1 illustrates as an example the deep learning architecture of DistMult. The value X represents a predefined embedding dimension where v and w are the number of unique nodes or relations, respectively. Before starting the training procedure, the AI framework will build the computational graph from this architecture: hence, the mentioned parameters X, v, and w are determined and cannot be changed anymore. Modifying parameters, or variables inside the computational graph during runtime is not envisaged, and not provided for according to existing AI frameworks. However, embodiments of the present invention recognize that new nodes and relations cause the need to change at least the shape of the training variables for the relation (100) and node embeddings (102) (i.e., the dimensions v and w).

Moreover, the optimizer used during training has several weight matrices whose shapes depend on the dimensions of the training variables. Independently, it might be needed to adapt the embedding dimension. FIG. 1 depicts features for generating the relation embeddings 104 and the node embeddings 106. FIG. 1 also depicts the joined embedding 108 generated by the deep learning architecture. In embodiments, a computational graph may refer to a directed graph where the nodes correspond to operations or variables. In FIG. 1, the node embedding 102 may be generated using inputs such as input node A 110 and input node B 112. FIG. 1 depicts score layer 114 for outputting score vector 116.

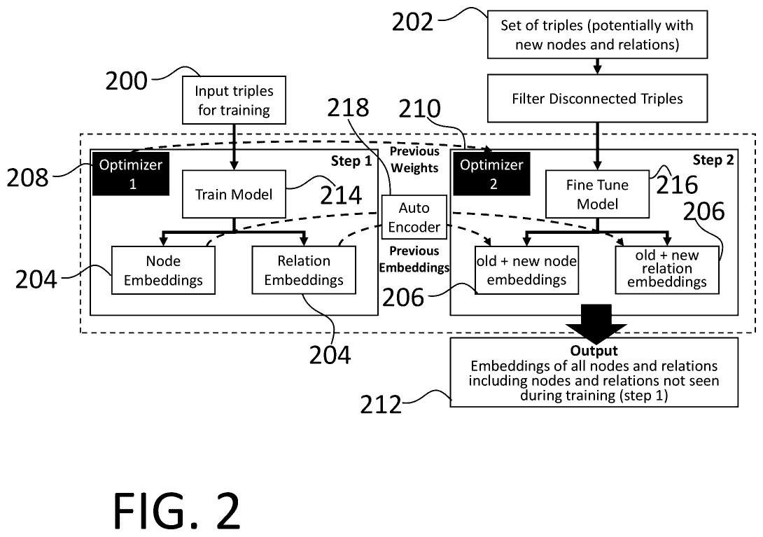

As shown in FIG. 2, the training process according to an embodiment of the present invention includes two steps: first, training on the initial training data 200 (Step 1) and second, training on additional data 202 (Step 2) that potentially contain new nodes and/or relations. The embeddings of existing nodes 204 obtained from the initial training data 200 are reused, while embeddings of new nodes 206 are randomly initialized. Alternatively, the new embeddings 206 are instantiated with zeros or through a pooling mechanism. By training on the additional data in Step 2, the AI model learns the embeddings 206 of the new nodes while utilizing the existing node embeddings 204. The weights of the neural network are updated through the optimizer 208, which can be applied to the entire network or only to the new nodes/relations while freezing the weights (non-trainable) of existing entities, depending on the user's choice. In embodiments, a pooling mechanism may include max pooling. average pooling, or sum pooling. The pooling mechanism describes how to combine a set of numerical vectors to get a single numerical vector of the same shape. For example, pseudocode representing a pooling mechanism may include:

list_vectors=[[2.1,4], [6,7,2], [[0,1,4]]:
result=sum_pooling (list_vectors), where the result would be [8, 9, 10].

From a technical point of view, Step 2 includes modifying the computational graph. This can be accomplished by creating a second computational graph on a graphics processing unit (GPU). However, embodiments of the present invention are not limited to the GPU: rather, other processors could also be used. The second computational graph is instantiated or compiled with the new parameters and dimensions. Then, the training variables and the respective weights of the first computational graph are migrated to the second computational graph. In this process, the assumption is that the new additional dimensions in the new training variables represent the new nodes and/or relations 206. Thus, in the simplest case, the weights of the training variables of the first computational graph are copied into the new training variables while keeping for all values the same position. For other cases, a mapping function is defined. A vector-to-vector machine learning model (e.g., an autoencoder) may be trained to obtain the mapping function.

Another technical change implemented according to embodiments of the present invention is the modification of the optimizer 208 and linking thereof to the new training variables. In the simplest case, the optimizer 208 could be re-instantiated. However, this would cause that all optimizer weights would be set to zero. This might be an issue especially when there is limited training data of the second training step. If it is to be expected that the second training step is a large dataset, resetting the state of the optimizer 208 could be helpful to avoid local optima or overfitting.

In an exemplary scenario, it is assumed that the first training data set 200 is large and the subsequent training steps go along with few updates (i.e., limited training data). In this scenario, another optimizer 210 with the same configuration as the first one can be instantiated on the GPU. Then, the training variables of the second computational graph are used to apply the gradients. For example, the gradients may describe how the training variables change (i.e., the gradients are used to update/modify the training variables). To continue the example, the training variables can be n-dimensional vectors and the gradients can be n-dimensional vectors of the same shape which are combined with the training variables (e.g., summed up). Here, it is advantageously provided that the gradients are all zero. This ensures that now the optimizer 210 knows the variables of the second computational graph. Further, the weights of the optimizer 210 have the correct dimension. Similar with the training variables, the weights of the first optimizer 208 are transferred to the second optimizer 210. Thus, in the simplest case, the weights of the optimizer are copied into a new weight matrix while keeping for all values the same position. The remaining positions are zero. The assumption is that the respective dimensions of the weight matrix have the same meaning, or in other words, that the extension of the dimension did not influence the behavior or meaning of the already existing dimensions. FIG. 2 depicts the training of the model 214 in Step 1 as well as fine tuning the model 216 at Step 2. Autoencoder 218 can be used while transferring the trainable variables between Step 1 and Step 2 as described herein.

As an example, the optimizers can be based on the ADAM optimizer (see Diederik, Kingma P., and Jimmy Ba, “Adam: A Method for Stochastic Optimization,” arXiv preprint arXiv: 1412.6980 (2017), which is hereby incorporated by reference herein). In embodiments the output 212 of the fine-tuned model includes embeddings of all nodes and relations (204 and 206) including nodes and relations not seen during training (e.g., Step 1). In embodiments, the trainable variables are created or instantiated in the optimizer. The trainable variables may be parameters of the neural network. For example, in a simple scenario, the neural network architecture has a single embedding layer with a size of (n,m). n can be the number of nodes and m the embedding dimension. The optimizer will automatically have a corresponding trainable variable (with the same dimension). In embodiments, the embedding vectors represent a learned representation of the nodes. The weights may represent the trainable variables. During a training process of the model, the weights may inform the model on how to modify the embedding vectors (numerical vectors). The model may continue to do this until it reaches a stable state.

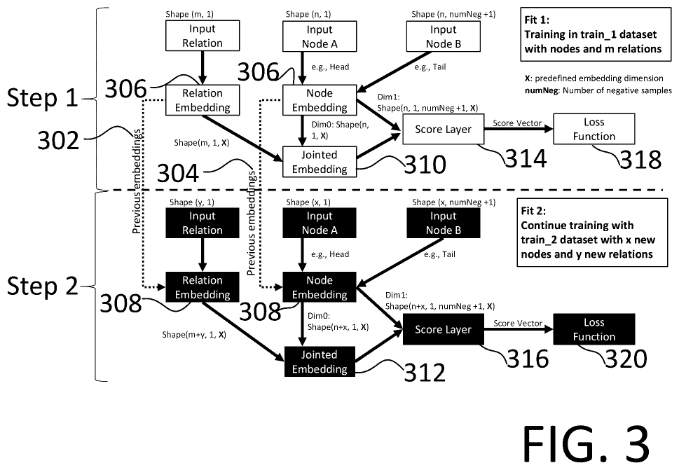

FIG. 3 illustrates how the first and the second computational graph are related. The upper part of the figure shows the training on the training data (Step 1) and the lower part of the figure shows training on the additional/new data (Step 2). The connectors between the “Relation Embeddings” 302 and “Node Embeddings” 304 illustrate that the embeddings learned in Step I are carried over to the new computational graph of Step 2. If the number of unique nodes in the training data (Step 1) is n and the number of unique relations is m, the size of the output matrix of the Embedding layer encoding the nodes is (n, 1, X) and the size of the output matrix of the embedding layer encoding the relations is (m, 1, X), where X is the specified embedding dimension number. When an additional dataset (Step 2) contains x number of new unique nodes and y number of new unique relations. the embeddings of the already existing nodes and relations 306 are essentially extended by the embeddings of the new nodes and relations 308. As a result. the size of the output matrix of the node embedding layer is (n+x, 1, X) and the size of the output matrix of the relation embedding layer is (m+y, 1, X). Within Step 1 of FIG. 3 and similar to FIG. 1. the relational and node embeddings 306 are used to generate a jointed embedding 310. In Step 2 of FIG. 3 the relational and node embeddings 308 are used to generate a jointed embedding 312. FIG. 3 also includes in both Steps 1 and 2 a corresponding score layer 314 and 316 as well as loss function 318 and 320.

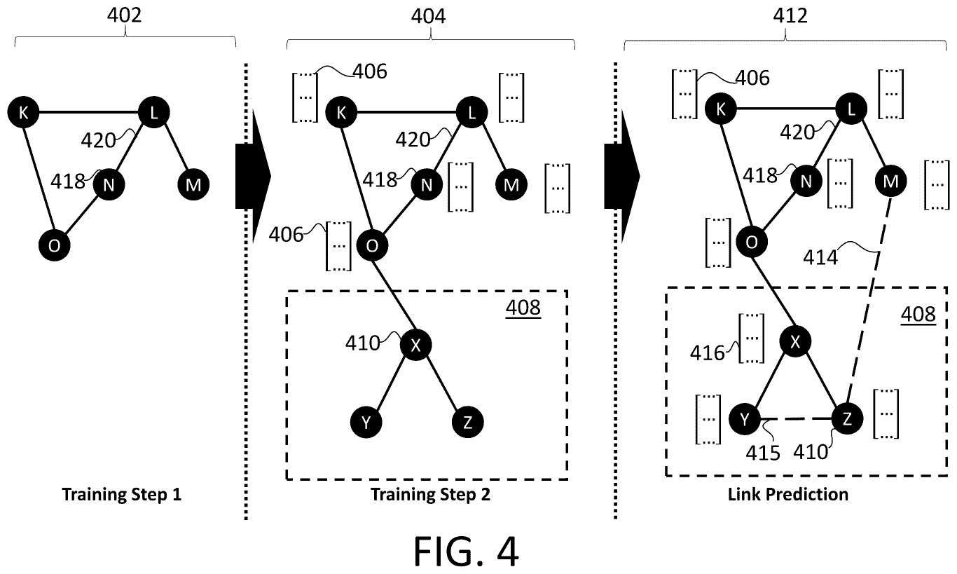

FIG. 4 illustrates a training procedure according to an exemplary embodiment. For training step 1. a neural network model that is provided input of a computational graph represented in 402 with nodes 418 and links 420 is compiled and trained as usual. For training step 2. the learned embeddings and the learned representation (embedding vector) 406 are used when building a new (e.g., updated or extended) computational graph for continuing the training of the neural network model with new data. represented in 404. In embodiments. an optimizer's weights may be used to generate the learned representation (embedding vector) 406. This results in extending the computational graph from 402 by adding new nodes 410. The advantage is that this procedure on the one hand can keep the entire operations on the GPU meaning that the learned embeddings and weights do not need to be moved between the central processing unit (CPU) and the GPU. but rather can be directly used to extend the computational graph represented in 402. In addition, the original AI model (neural network model) stays available for processing requests while performing the update of the AI model. Training step 2 of FIG. 4 represents the computation of embeddings 416 for the new nodes 410. The computation of the embeddings 416 for the new nodes 410 enables the link prediction 408 for the nodes 410. The link prediction 408 represented in 412 depicts the ability of the model to determine a predicted link 414 between the nodes of the original computational graph represented in 402 with the new nodes 410, as well as a predicted link 415 between the new nodes 410. Embeddings 416 may also be determined for the new computational graph of 404. In embodiments, the predicted links 414 and 415 may be determined using any suitable link prediction algorithm such as DistMult having determined the embedding vectors 406 and 416.

To apply to some use cases, embodiments of the present invention provide to additionally adapt the embedding dimension. For example, an increasing number of entities over time might lead to the issue that the embedding dimension is not capable anymore to provide reliable and distinguishable representations. In this case, an unsupervised autoencoder can be used while transferring the trainable variables (sometimes referred to as training variables) from the previous computational graph to the new computational graph. The autoencoder takes all trainable variables as input to find a function which can extend or compress the input in a lossless way. Further, it is ensured that the conversion manages the ratio of the original distances between the vectors in the vector space.

Embodiments of the present invention are not restricted to graph data, but can also be used with classical tabular data.

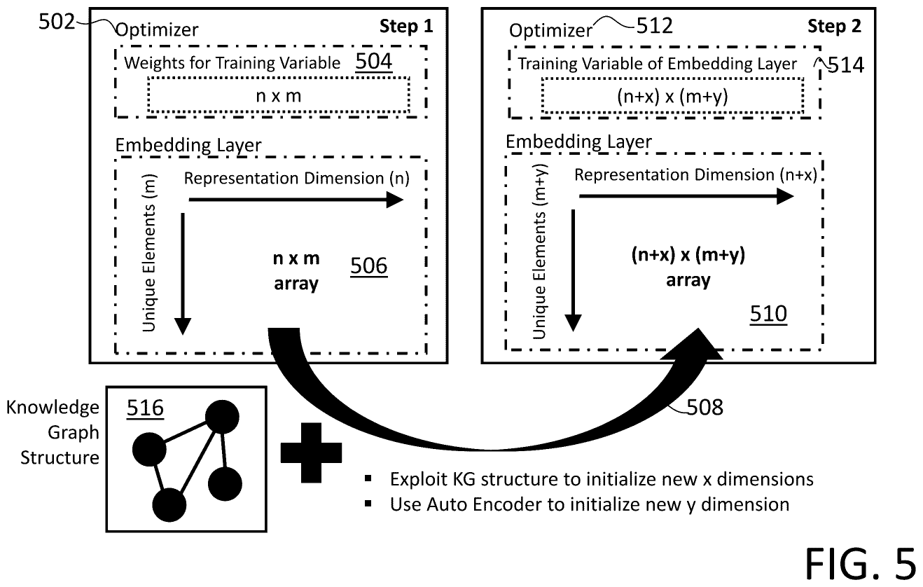

FIG. 5 illustrates the different dimensions, which potentially are adapted when going, e.g., in FIG. 2 from Step 1 to Step 2. FIG. 5 depicts optimizer 502 for Step 1 which may determine the training variables and respective weights 504 of the first computational graph of Step 1. The illustration of Step 1 of FIG. 5 also depicts, in the embedding layer, a n ×m array 506. As illustrated in FIG. 5, a transition 508, between Step 1 and Step 2 occurs where the computational graph of step 1 is used to initialize new x dimensions for the second computational graph of step 2. In embodiments an autoencoder may be used to initialize new y dimensions for the array 510 of the embedding layer in Step 2. As described herein, the optimizer 502 may pass the weights for training variables 504 to a new optimizer 512. The training variables of embedding layer 514 may include the embeddings of existing nodes obtained from the initial training data from Step 1. In some embodiments, the embeddings of the new nodes may be randomly initialized or instantiated with zeros, or through a pooling mechanism. FIG. 5 depicts knowledge graph structure 516 which may be updated to include new nodes or entities as well as relational links between the new nodes or entities and nodes and entities from Step 1. In embodiments, the optimizer 502 and new optimizer 512 represent an instance of a class. Creating new optimizer 512 may correlate to creating a new instance of the optimizer with new parameters. A pseudocode example may be represented as Optimizer =new Optimizer (parameters).

Embodiments of the present invention thus provide for general improvements to computers in machine learning systems to improve the computational performance, reliability and accuracy of Al systems by enabling efficient and dynamic integration of new information. Moreover, embodiments of the present invention can be practically applied to use cases to effect further improvements in a number of technical fields including, but not limited to, medical (e.g., digital medicine, personalized healthcare, AI-assisted drug or vaccine development, etc.), smart cities (e.g., automated traffic or vehicle control, smart districts, smart buildings, smart industrial plants, smart agriculture, energy management, etc.) and automated product design and manufacturing.

In an embodiment, the present invention can be applied to an Al system for product design and smart manufacturing solutions, for example, for food product design. Here, a use case could be accurately predicting the combination of product features that are most likely to increase the likelihood of a purchase, such that companies can tailor their offerings to meet customer demands effectively. This not only enhances customer satisfaction, but also leads to improved sales performance and market competitiveness. It is time-consuming and computational resource intensive to analyze different combinations of product features based on customer preferences and train machine learning models for each new product design. Businesses require a more efficient solution, in terms of time and computational resources that allows them to analyze and evaluate new product features on the go, without the need for extensive re-training of models. Using an AI system according to an embodiment of the present invention, businesses can seamlessly integrate new product features into their existing AI models and leverage the knowledge gained from previous training iterations. This enables real-time analysis of different feature combinations and their impact on customer preferences, without the need to start from scratch with each new product design. The data source for this use case includes data containing product features, customer features, purchase records, and optionally, review data. These datasets provide valuable insights into customer preferences, product characteristics, and historical purchasing patterns. Application of the method according to an embodiment of the present invention predicts, through inductive link prediction, the new product features and customer preferences with an explanation for the assessment by extending the knowledge graph with novel product features. Further, application of the method according to an embodiment of the present invention provides to learn embeddings of new product features, allowing for the incorporation of new entities into the existing knowledge graph. This enables the model to adapt and make predictions based on both known entities and newly introduced elements. There is no re-training of the AI model from scratch required, and new entities can be handled on demand and do not need to be considered while deploying the Al system according to an embodiment of the present invention. The output can be a novel set of product features, which allows businesses to prioritize the most promising product combinations for increasing sales and customer engagement. As automated actions or technicity, the predicted product features can be used for a smart industrial plant or automated production assembly line for producing new products (e.g., drinks).

In an embodiment, the present invention can be applied to an AI system for a smartcity application or public safety, for example, in an automated forensic tool for incident or criminal investigation. Here, a use case could be providing the police force with an automated forensic tool for crime investigation. In particular, the AI system embedding a computer-implemented method according to an embodiment of the present invention can be used, e.g., in a preliminary investigation to assess a current situation. The AI system according to an embodiment of the present invention can be used right away without re-training from scratch even if the crime case involves new elements. The output of the AI system, which in this case can be the automated forensic tool, is an assessment of the current situation. Further, embodiments of the present invention enable that a police officer can add new elements (e.g., the presence or absence of certain items) to simulate how the assessment changes, e.g., how likely it is that the crime will be solved. The data source for this use case includes available sensor networks (e.g., camera, weather station, and presence sensors), the database of the police force (e.g., past crime case records) and sociodemographic information (e.g., characteristics of the social life in the district of interest). Application of the method according to an embodiment of the present invention predicts, through inductive link prediction, the new crime case of interest, and the chance of success by extending the knowledge graph with new crime cases and new evidence. There is no re-training of the AI model from scratch required, and new entities can be handled on demand and do not need to be considered while deploying the AI system according to an embodiment of the present invention. The output can be a solvability score for each crime as an assessment reflecting the chance of success in solving the crime. As automated actions or technicity, the information is displayed to a user (e.g., police officer), which influences how to interact with the device, and credibly assists the user in performing a technical task by means of a continued and/or guided human-machine interaction process.

Another use case in smartcities and public safety relates to saving both human and computational resources in policing, which is especially advantageous as there are not enough resources for all crime cases. Law enforcement have essentially a limited budget in terms of resources and can benefit especially from automated AI tools to extend their capacities, or to enable that one police officer can do the work of two or more. Providing an automated forensic tool that embeds a method according to the present invention allows to continuously evaluate a situation. For instance, the forensic tool could automatically simulate which elements (e.g., nodes of a computation or knowledge graph), which are not part of the current investigation, would increase the chance of success. The output of the AI system according to an embodiment of the present invention, which in this case can be the automated forensic tool, can be used to control other technical devices, e.g., those that collect evidence, such as drones, sensors or cameras. The data source for this use case includes available sensor networks (e.g., camera, weather station, and presence sensors), other (smart) forensic tools, the database of the police force (e.g., past crime case records), sociodemographic information (e.g., characteristics of the social life in the district of interest), cameras, etc. Application of the method according to an embodiment of the present invention predicts, through inductive link prediction, for a new crime case of interest, the chance of success. Further, application of the method according to an embodiment of the present invention adds and removes iteratively certain elements (e.g., evidence types) to estimate to which extent those would increase the chance of success. Those estimations can be used to control other devices like cameras and drones to look for additional specific evidence. Their findings can be new input to the system according to an embodiment of the present invention. The output can be an initial solvability score for each crime (an assessment), and how additional elements (e.g., evidence types) would influence the solvability score. As automated actions or technicity, the output of the AI system according to an embodiment of the present invention can directly be used to control other forensic tools at crime places such as drones, androids, sensors, cameras (e.g., body-cameras), etc. In particular, the output of the AI system can control these devices and also instruct them which evidence types need to be focused on. This is especially advantageous to enable investigation in scenarios where humans cannot enter the crime place.

In an embodiment, the present invention can be applied to a biomedical AI system for discovery of structurally distinguished molecules, for example, for AI-assisted drug design. Here, a use case could be addressing the development of new drugs, which is increasingly necessary as humans adapt to existing antibiotics. The development of new drugs goes along with so called wet lab experiments. A wet lab is a type of laboratory in which a wide range of experiments are performed, including characterizing of enzymes in biology and titration in chemistry. Therefore, wet lab experiments take time and are expensive, in terms of personal, physical and computational resources, and at the same time there are an enormous number of possible combinations which can be analyzed. Therefore, a researcher must decide at some point whether it is worth the resources to continue wet lab experiments for a particular drug or to continue with the next step. In such a scenario, an AI system according to an embodiment of the present invention can help to discover molecules which are structurally distinct from a known antimicrobial (e.g., an antibiotic), and can also help to identify a small subset of molecules out of millions of molecules which are potentially of interest for the development of a new drug. Embodiments of the present invention enable to model such complex structures (e.g., molecules) including related attributes (e.g., mass, shape, and physical properties). This is especially advantageous as the amount of information for this use case is already huge and grows daily, and embodiments of the present invention can process and exploit the new information without re-training the AI model. The data source for this use case can be any available protein, drug, disease information including DNA data amino acid sequences. Application of the method according to an embodiment of the present invention predicts, through inductive link prediction, potential states or assumptions. In particular, the underlying AI model of the Al system according to an embodiment of the present invention estimates missing parts which should be there. The AI model can be continuously updated with new information leading to new and more accurate predictions. The output can be a set of potential states or links which reveal new relations. As automated actions or technicity, the output of the system can be provided to a user for use/evaluation to adjust a device for the wet lab experiments (e.g., an autoclave or spectrophotometer). Alternatively, the devices can be directly adjusted in an automated fashion without the human in the loop.

In an embodiment, the present invention provides a method for inductive link prediction, for new entities, the method comprising the following steps:

1. Train an arbitrary embedding-based neural network with a given dataset.
2. When a new dataset arrives which extends the first one:
a. Create on the same GPU a new computational graph of the same model but instantiate it with the new dimensions.
b. Migrate the weights of the trainable variables from the previous one to the new computational graph.
c. In some embodiments, if the embedding dimension was modified, apply a lossless autoencoder to the weights of the trainable variables to match the new embedding dimension.
d. In some embodiments, instead of keeping them zero, instantiate the new dimensions of the embeddings with random values or use a pooling mechanism based on the neighborhood in the graph.
e. Create a new optimizer on the same GPU, where the weight matrix fits to the trainable variables of the new computational graph.
f. Migrate the weights of the previous optimizer to the new optimizer.
g. In some embodiments, instead of keeping them zero, instantiate the new dimensions of the optimizer's weights with random values or use a pooling mechanism based on the neighborhood in the graph.
   3. Train the new model with the new datasets to update the existing embeddings and to learn the new embeddings of the new entities.
   4. Remove the previous computational graph and optimizer from the GPU.
   5. Return to Step 2 when further new data arrives.

Embodiments of the present invention provide for the following improvements and technical advantages over existing technology:

1) While using the first, trained computational graph on the GPU, creating a second one in parallel so that the update process does not disrupt the productive system (see Steps 2.b. and 2.e. of the foregoing method).
a. This includes the migration of trainable variables and the optimizer weights on the GPU on the fly to the new computational graph and the respective optimizer.
b. In doing so, the new dimensions (which represent the new entities) of the target trainable variables and the optimizer weights are instanced (pooling) by leveraging from the graph structure.
   2) Utilizing an unsupervised autoencoder, coupled with the seamless transfer of trainable variables from the previous computational graph to the new computational graph, to facilitate the projection of the values to the new dimension, which enables the modification of the embedding dimensions at a certain point in time without the need to re-train the model (see Step 2.c. of the foregoing method). In embodiments the modification of the embedding dimensions is use case dependent. For example, if a dataset becomes more complex over time (due to extensions) the original embedding dimension may not be capable of capturing the new complexity. In such a case, the user can extend the embedding dimension.
   3) By integrating incremental machine learning with a generalized link prediction embedding representation function, enabling the process of inductive link prediction. The representation function generates initial embeddings for newly introduced entities, which are subsequently refined (together with all other embeddings) through ongoing model training using the new data.

In contrast to other proposed solutions to the technical problem of handling new nodes (or training data) after the initial training, embodiments of the present invention provide for a number of improvements. The other proposed solutions focus on generalizing the method or function to embed new entities. Although this does not always require to continue the training of the model, it has the disadvantage that certain parameters or elements need to be fixed (e.g., it can only handle new nodes, but not new relations, or the other way around). In contrast, embodiments of the present invention enable that all parameters can be adapted to improve performance and avoid that the embeddings water down over time.

Existing technology for inductive link prediction are NodePiece (see Galkin, Mikhail, Etienne Denis, Jiapeng Wu, and William L. Hamilton, “NodePiece: Compositional and Parameter-Efficient Representations of Large Knowledge Graphs,” arXiv: 2106.12144 (2022), which is hereby incorporated by reference herein) and Neural Bellman-Ford Networks (NBFNet) (see Zhu, Zhaocheng, Zuobai Zhang, Louis-Pascal Xhonneux, and Jian Tang. “Neural Bellman-Ford Networks: A General Graph Neural Network Framework for Link Prediction,” NeurIPS 2021, arXiv: 2106.06935 (2022), which is hereby incorporated by reference herein). NodePiece represents each node as a set of top-k nearest anchor nodes. As such, NodePiece works only in a semi-inductive setting, and any new unseen incoming node must be attached to an already existing and seen graph as it generalizes the embedding representation. In contrast, embodiments of the present invention do not generalize the embedding representation, thereby advantageously providing that it is fully flexible and does not water down the embeddings over time. Also, in contrast to embodiments of the present invention, NBFNet does not learn node embeddings, but only relational embeddings through traditional path-based methods and graph neural network (GNN) weights. Disadvantages of this approach of NBFNet compared to embodiments of the present invention is that it struggles in learning good representations in sparse graphs, cannot handle node features, and considers only one kind of relation. In contrast, embodiments of the present invention are not restricted to graph data and are capable of handling different types of relations.

Trouillon, Theo, Johannes Welbl, Sebastian Riedel, Éric Gaussier, and Guillaume Bouchard, “Complex embeddings for simple link prediction,” arXiv: 1606.06357 (2016), is hereby incorporated by reference herein. This reference describes using an algorithm to provide link prediction. However, in contrast to the embodiments of the present invention, this reference fails to account for or address the issue of unseen nodes. Instead, the reference describes a situation where the node representations (embedding vectors) were already somehow learned, or a situation where all the data is given at the beginning without any updates at a later point in time.

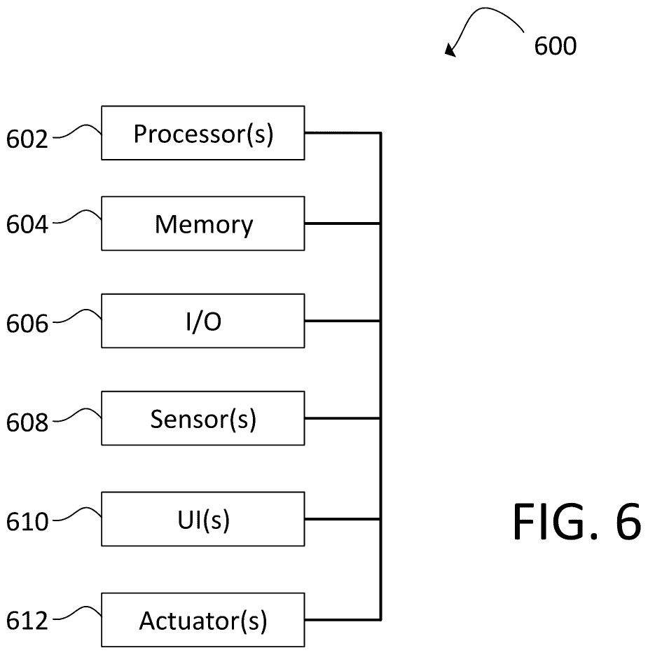

Referring to FIG. 6, a processing system 600 can include one or more processors 602, memory 604, one or more input/output devices 606, one or more sensors 608, one or more user interfaces 610, and one or more actuators 612. Processing system 600 can be representative of each computing system disclosed herein.

Processors 602 can include one or more distinct processors, each having one or more cores. Each of the distinct processors can have the same or different structure. Processors 602 can include one or more central processing units (CPUs), one or more graphics processing units (GPUs), circuitry (e.g., application specific integrated circuits (ASICs)), digital signal processors (DSPs), and the like. Processors 602 can be mounted to a common substrate or to multiple different substrates.

Processors 602 are configured to perform a certain function, method, or operation (e.g., are configured to provide for performance of a function, method, or operation) at least when one of the one or more of the distinct processors is capable of performing operations embodying the function, method, or operation. Processors 602 can perform operations embodying the function, method, or operation by, for example, executing code (e.g., interpreting scripts) stored on memory 604 and/or trafficking data through one or more ASICs. Processors 602, and thus processing system 600, can be configured to perform, automatically, any and all functions, methods, and operations disclosed herein. Therefore, processing system 600 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 600 can be configured to perform task “X”. Processing system 600 is configured to perform a function, method, or operation at least when processors 602 are configured to do the same.

Memory 604 can include volatile memory, non-volatile memory, and any other medium capable of storing data. Each of the volatile memory, non-volatile memory, and any other type of memory can include multiple different memory devices, located at multiple distinct locations and each having a different structure. Memory 604 can include remotely hosted (e.g., cloud) storage.

Examples of memory 604 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 604.

Input-output devices 606 can include any component for trafficking data such as ports, antennas (i.e., transceivers), printed conductive paths, and the like. Input-output devices 606 can enable wired communication via USBR, Display Port®, HDMIR, Ethernet, and the like. Input-output devices 606 can enable electronic, optical, magnetic, and holographic, communication with suitable memory 606. Input-output devices 606 can enable wireless communication via WiFiR, Bluetooth®, cellular (e.g., LTER, CDMAR, GSMR, WiMax®, NFCR), GPS, and the like. Input-output devices 606 can include wired and/or wireless communication pathways.

Sensors 608 can capture physical measurements of environment and report the same to processors 602. User interface 610 can include displays, physical buttons, speakers, microphones, keyboards, and the like. Actuators 612 can enable processors 602 to control mechanical forces.

Processing system 600 can be distributed. For example, some components of processing system 600 can reside in a remote hosted network service (e.g., a cloud computing environment) while other components of processing system 600 can reside in a local computing system. Processing system 600 can have a modular design where certain modules include a plurality of the features/functions shown in FIG. 6. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for a dynamic embedding-based machine learning training mechanism, the computer-implemented method comprising:
a) training, using an initial optimizer on a processor, an embedding-based neural network model based on a data set to generate an initial computational graph having trainable variables:
b) based on receiving a new data set that extends the data set:
generating, on the processor, a new computational graph of the embedding-based neural network model instantiated with new embedding dimensions migrated from the initial computational graph, the new computation graph having the trainable variables:
generating a new optimizer on the processor based on a weight matrix that fits to the trainable variables of the new computational graph: and migrating weights of the trainable variables from the initial optimizer to the new optimizer; and
c) training the embedding-based neural network model with the new data set by updating embeddings of the embedding-based neural network model and learning new embeddings of the new data set.

2. The computer-implemented method according to claim 1, further comprising predicting relational links for the new embeddings such that one or more new entities are connected to each other and/or to one or more existing entities using a link prediction embedding representation function, wherein the embeddings and the new embeddings are iteratively refined based on repeating steps b) and c) for further new data sets.

3. The computer-implemented method according to claim 1, further comprising removing the initial computational graph and the initial optimizer from the processor.

4. The computer-implemented method according to claim 1, further comprising applying a lossless autoencoder to the weights of the trainable variables to match the new embedding dimensions, wherein the lossless autoencoder is an unsupervised autoencoder, and wherein applying the lossless autoencoder is based on an embedding dimension of the trainable variables from the initial computational graph being modified.

5. The computer-implemented method according to claim 1, wherein a mapping function is defined to migrate the weights of the trainable variables from the initial optimizer to the new optimizer, wherein the mapping function is obtained using a vector-to-vector machine learning model.

6. The computer-implemented method according to claim 1, wherein the processor is a graphics processing unit (GPU), and wherein all operations of the initial computational graph and the new computational graph are maintained on the GPU.

7. The computer-implemented method according to claim 1, further comprising instantiating the new embedding dimensions and/or the weights of the trainable variables with at least random values, using a pooling mechanism based on a neighborhood of the new computational graph, or with zeros.

8. The computer-implemented method according to claim 1, wherein the embedding-based neural network model is used on the processor to predict potential states from the data set in parallel to training, on the processor, the embedding-based neural network model.

9. The computer-implemented method according to claim 1, further comprising identifying a subset of molecules from the new data set using the embedding-based neural network model, the new data set including amino acid sequences, wherein the subset of molecules is distinct from an antibiotic.

10. The computer-implemented method according to claim 1, wherein the trainable variables for the initial computational graph include a predefined embedding dimension, relation embeddings, and node embeddings.

11. The computer-implemented method according to claim 1, further comprising removing certain evidence types from the new data set using the embedding-based neural network model, the new data set including devices used to obtain evidence or information associated with the evidence, wherein the certain evidence types correspond to a particular device of the devices or a particular piece of the evidence or the information of the evidence or the information.

12. The computer-implemented method according to claim 1, wherein the new optimizer is a re-instantiated version of the initial optimizer, the re-instantiated version of the new optimizer instantiated with new and/or different parameters.

13. A computer system for interpretable domain adaptation for a dynamic embedding-based machine learning training mechanism, the computer system comprising one or more hardware processors which, alone or in combination, are configured to provide for execution of the following steps:
a) training, using an initial optimizer on a processor, an embedding-based neural network model based on a data set to generate an initial computational graph having trainable variables:
b) based upon receiving a new data set that extends the data set:
generating, on the processor, a new computational graph of the embedding-based neural network model instantiated with new embedding dimensions migrated from the initial computational graph, the new computation graph having the trainable variables:
generating a new optimizer on the processor based on a weight matrix that fits to the trainable variables of the new computational graph:
migrating weights of the trainable variables from the initial optimizer to the new optimizer; and
c) training the embedding-based neural network model with the new data set by updating embeddings of the embedding-based neural network model and learning new embeddings of the new data set.

14. The computer system of claim 15, further comprising predicting relational links for the new embeddings such that one or more new entities are connected to each other and/or to one or more existing entities using a link prediction embedding representation function, wherein the embeddings and the new embeddings are iteratively refined based on repeating steps b) and c) for further new data sets.

15. A tangible, non-transitory computer-readable medium having instructions thereon which, upon being executed by one or more processors, provide for interpretable domain adaptation for a dynamic embedding-based machine learning training mechanism by execution of the following steps:
a) training, using an initial optimizer on a processor, an embedding-based neural network model based on a data set to generate an initial computational graph having trainable variables;
b) based upon receiving a new data set that extends the data set:
generating, on the processor, a new computational graph of the embedding-based neural network model instantiated with new embedding dimensions migrated from the initial computational graph, the new computation graph having the trainable variables;
generating a new optimizer on the processor based on a weight matrix that fits to the trainable variables of the new computational graph;
migrating weights of the trainable variables from the initial optimizer to the new optimizer; and
c) training the embedding-based neural network model with the new data set by updating embeddings of the embedding-based neural network model and learning new embeddings of the new data set.
